(19) United States
(12) Patent Application Publication
(10) Pub. No.: US 2026/0096573 A1
(43) Pub. Date: Apr. 9, 2026

(54) Variety of Coffee Flavors Packaged in Individual Ready-to-Go Cans or Bottles and Take-Home Box Packaging

(71) Applicant: Josh Rivers, Watertown, MA (US)

(72) Inventor: Josh Rivers, Watertown, MA (US)

(21) Appl. No.: 19/084,505

(22) Filed: Mar. 19, 2025

Related U.S. Application Data
(60) Provisional application No. 63/705,417, filed on Oct. 9, 2024.
(60) Provisional application No. 63/712,699, filed on Oct. 28, 2024.

(51) Int. Cl. A23F 5/24; A23F 5/46; B65B 17/02; B65D 17/28; B65D 71/36; B65D 85/72

(52) U.S. Cl. CPC A23F 5/243; A23F 5/465; B65B 17/02; B65D 17/4012; B65D 71/36; B65D 85/72

(57) ABSTRACT

A variety of coffee flavors packaged in individual pop-top cans or bottles for retail sale. The invention includes a broad selection of unique coffee flavors, such as Almond, Chocolate Marshmallow, Pumpkin Spice, and Toasted Marshmallow, sold in individual 330 ml or 355 ml containers. These beverages are pre-mixed, shelf-stable, and ready-to-drink, offering consumers the convenience of enjoying barista-style coffee without visiting a coffee shop. The containers are also packaged in take-home boxes that hold 8, 12, or 24 units, making it easy for consumers to purchase multiple flavors in one package from grocery stores, convenience stores, and liquor stores.

### CROSS-REFERENCE TO RELATED APPLICATION

This application claims the benefit of and priority to U.S. Provisional Patent Application No. 63/705,417 , filed Oct. 9, 2024; U.S. Provisional Patent Application No. 63/712,699 , filed Oct. 28, 2024; and U.S. Provisional Patent Application No. 63/740,598 , filed Dec. 31, 2024, the contents of all of which are incorporated herein by reference.

### FIELD OF THE INVENTION

This invention relates to a variety of coffee flavors packaged in cans, bottles, or packaging.

### BACKGROUND OF INVENTION

In recent years, the demand for ready-to-drink (RTD) coffee beverages has seen significant growth, driven by consumers' desire for convenience and variety. As consumers have become more health-conscious and time-constrained, the demand for high-quality, pre-packaged coffee beverages has surged.

While many coffee shops offer a limited selection of flavored coffees, often using basic syrups like caramel, vanilla, or chocolate. There is a gap in the market for a broad range of coffee flavors that consumers can purchase directly from stores in ready-to-go packaging. Current RTD coffee offerings are often limited to basic flavors such as caramel or vanilla, and consumers must visit coffee shops to experience a wider range of flavors.

This invention addresses that gap by introducing a wide variety of unique and inventive coffee flavors, packaged in pop-top cans or bottles that are sold individually and conveniently packaged in boxes for take-home use. These flavors span traditional options as well as more innovative and dessert-like flavors, allowing consumers to enjoy barista-style coffees without the need to visit a coffee shop. The coffee is pre-mixed, shelf-stable, and available in packaging that is ideal for grocery store purchases.

### SUMMARY OF THE INVENTION

There are additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

The subject invention discloses a packaged coffee beverage product containing a plurality of individual beverage containers, each filled with a distinct coffee flavor from a predefined list, including but not limited to Almond, Caramel Vanilla Latte, Chocolate Peanut Butter Cup, Cinnamon Roll, and S'mores. Each container is a pop-top can or bottle, designed for single-serving consumption. The coffee beverage is a pre-mixed blend of coffee, milk or milk substitutes, sweeteners or sugar substitutes, and natural or artificial flavorings. The beverage is shelf-stable and requires no preparation prior to consumption.

The subject invention also discloses a method of packaging coffee beverages involves preparing a variety of flavored coffee beverages, each incorporating a distinct combination of coffee, milk or milk substitutes, sweeteners, and flavorings. These beverages are filled into individual beverage containers and packaged into take-home boxes capable of holding 8, 12, or 24 units. The packaging is designed for sale in grocery stores, convenience stores, and liquor stores.

The subject invention further discloses a coffee beverage variety pack includes at least two distinct coffee flavors selected from a group consisting of dessert flavors, seasonal flavors, fruit-based flavors, nut-based flavors, and classic coffee flavors. Each flavor is packaged in an individual can or bottle, clearly labeled. The beverage inside each container is pre-mixed and shelf-stable. A packaging box securely holds and displays the beverage containers.

The subject invention discloses a single-flavor packaged coffee beverage product includes a plurality of cans or bottles, each containing an identical coffee flavor. The coffee beverage is pre-mixed with coffee, milk or milk substitutes, sweeteners, and natural or artificial flavorings. The packaging is designed for take-home use in quantities of 8, 12, or 24 containers.

The subject invention further discloses a flavored coffee beverage product for retail sale comprises a plurality of pop-top cans or bottles, each filled with a pre-mixed coffee beverage. At least one coffee flavor is selected from a group including but not limited to French Vanilla, Pumpkin Spice, Maple, Mocha Mint Café, and Peppermint. The beverage is formulated for immediate consumption without the need for preparation.

The subject invention also discloses a ready-to-drink coffee beverage system includes individual servings of flavored coffee in resealable bottles or cans. Each serving contains coffee, a dairy or non-dairy component, a sweetening agent, and a flavoring ingredient. The beverage is formulated to remain shelf-stable for extended storage and distribution.

The subject invention additionally discloses a method of manufacturing a flavored coffee beverage involves selecting a base coffee blend for use in multiple flavors, mixing the base coffee with a variety of flavor additives including syrups, extracts, and natural ingredients, and packaging each flavored coffee into individual pop-top cans or bottles for single-serving consumption.

The subject invention discloses a method of distributing flavored coffee beverages includes selling individual flavored coffee cans or bottles in retail settings such as grocery stores and convenience stores. The method further involves providing take-home packaging that holds multiple units of flavored coffee beverages for consumer convenience and offering a selection of flavors that include seasonal variations, dessert-based options, and gourmet blends.

The subject invention further discloses a coffee beverage container is a sealed, single-serving aluminum can or bottle. The container includes a pre-mixed, shelf-stable coffee beverage with at least one distinct flavor selected from a predefined list of coffee flavors. A pop-top or resealable cap is provided for controlled dispensing.

The subject invention also discloses a multi-pack coffee beverage system for consumers includes a take-home packaging box capable of holding 8, 12, or 24 individual coffee beverage containers. Each container contains a unique coffee flavor formulated with coffee, milk or milk substitutes, sweeteners, and natural or artificial flavorings. The outer packaging displays the selection of flavors contained within the package for consumer convenience.

The subject invention additionally discloses a variety-pack coffee beverage product includes a plurality of individual beverage containers, each containing a different flavored coffee beverage. The coffee beverages include at least one selection from each of the following categories: classic flavors, nut-based flavors, fruit-based flavors, dessert-inspired flavors, and seasonal flavors. Each container is a pop-top can or resealable bottle. The beverage is pre-mixed and shelf-stable, requiring no refrigeration before consumption.

The subject invention also discloses a single-serving flavored coffee beverage product includes a container holding a coffee beverage mixture of coffee, milk or milk substitutes, and a sweetener. A unique flavoring is selected from a group including but not limited to Almond, Caramel Pecan Pie, Chocolate Fudge Brownie, Peppermint, and Irish Cream. The beverage is designed for direct consumption from the container.

The subject invention further discloses a method for preparing a variety of flavored coffee beverages includes mixing a base coffee formula with a set of distinct flavoring agents to create a plurality of unique flavored coffee beverages, packaging each flavored coffee in a single-serving container for direct consumer use, and arranging multiple containers into a take-home box designed for retail sale.

The subject invention discloses a pre-packaged multi-flavor coffee beverage system includes a first container holding a first coffee flavor, a second container holding a second coffee flavor distinct from the first, and at least one additional container holding a third coffee flavor, wherein each flavor is selected from a set of over 50 options. The containers are individually sealed and packaged together for consumer purchase.

The subject invention additionally discloses a method for providing customizable coffee variety packs involves allowing consumers to select from a range of flavored coffee beverages, packaging the selected flavors into a take-home box that holds between 8 and 24 units, and providing clear labeling on both the individual containers and the outer packaging to indicate the flavors contained within.

The subject invention further discloses a shelf-stable flavored coffee beverage product includes a coffee mixture combined with milk, a milk substitute, or a sweetening agent. At least one flavor is selected from a category including nut-based flavors, fruit-based flavors, caramel-based flavors, chocolate-based flavors, and spice-based flavors. A single-serving aluminum can or bottle is designed to maintain product freshness without refrigeration.

The subject invention also discloses a coffee beverage product packaged in aluminum cans includes a plurality of coffee flavors packaged in individual 330 ml or 355 ml aluminum cans with pop-top openings. The coffee mixture contains coffee, flavoring agents, milk or milk substitutes, and sweeteners. The cans are designed for single-use consumption.

The subject invention discloses a multi-container flavored coffee beverage pack includes a combination of at least two different coffee flavors packaged within a single take-home box. The beverages are pre-mixed and designed for direct consumption. The packaging provides consumer-friendly descriptions of the included flavors.

The subject invention also discloses a coffee beverage container with resealable capabilities includes a bottle or can containing a pre-mixed flavored coffee beverage. A resealable cap is included to allow for multi-use consumption. The beverage contains a combination of coffee, milk or milk substitutes, sweeteners, and natural or artificial flavorings.

The subject invention further discloses a process for producing ready-to-drink flavored coffee beverages includes brewing coffee to serve as a base ingredient, mixing the base coffee with a variety of flavoring ingredients to create multiple distinct flavors, and packaging the beverages into individual cans or bottles for consumer use.

The subject invention additionally discloses a flavored coffee beverage sold in grocery stores and convenience stores includes a single-serving container filled with a flavored coffee beverage. The beverage is designed for purchase as an individual unit or as part of a multi-pack. The flavor is pre-determined from a selection including Chocolate Truffle, Toasted Marshmallow, Maple Hazelnut, or Snickerdoodle.

The subject invention discloses a portable flavored coffee beverage system includes a plurality of beverage cans or bottles, each containing a distinct flavored coffee mixture. The coffee beverages are designed for transport and on-the-go consumption. The flavors include seasonal variations and limited-edition options.

The subject invention also discloses a flavored coffee beverage formulated for extended shelf life includes a combination of brewed coffee, stabilizers, and preservatives to maintain product freshness. A packaging system is designed to prevent flavor degradation. The beverage is available in flavors including Mocha Mint, Cinnamon Roll, Butter Pecan, and Crème Brûlée.

The subject invention further discloses a coffee beverage variety pack for holiday or seasonal sales includes a curated selection of coffee flavors including at least one seasonal option such as Peppermint Mocha, Pumpkin Spice, or Eggnog. A take-home packaging box is specifically designed for seasonal promotions. The beverages are individually packaged for single-serving use.

The subject invention additionally discloses a single-serving ready-to-drink flavored coffee beverage includes a can or bottle filled with a pre-mixed flavored coffee drink. The beverage is formulated to retain optimal taste and consistency without refrigeration. A flavor is selected from a list including Mexican Chocolate, Dark Mocha, Hazelnut Praline, and Chai Spice.

The subject invention also discloses a method of creating gourmet coffee flavor blends for packaged beverages includes combining specialty coffee beans with gourmet flavoring agents, formulating the mixture to ensure a balanced taste and aroma, and packaging the final product into single-serving cans or bottles.

The subject invention discloses a method of retail distribution for pre-packaged flavored coffee beverages includes supplying a selection of ready-to-drink coffee beverages in individual cans or bottles, distributing the beverages through grocery stores, convenience stores, and online retailers, and offering multi-pack packaging for bulk purchases.

In other embodiments of the subject invention, each individual container is hermetically sealed to preserve freshness and extend shelf life. In other embodiments of the subject invention, the coffee is cold-brewed to enhance smoothness and reduce acidity. In other embodiments of the subject invention, the coffee is nitrogen-infused to create a creamy texture without the need for additional dairy. In other embodiments of the subject invention, the beverage is formulated with organic coffee beans. In other embodiments of the subject invention, the beverage is made with fair-trade certified coffee beans to promote ethical sourcing. In other embodiments of the subject invention, the beverage is decaffeinated through a natural water process. In other embodiments of the subject invention, the beverage contains added functional ingredients such as collagen, protein, or MCT oil for enhanced health benefits. In other embodiments of the subject invention, the beverage contains adaptogens such as ashwagandha, ginseng, or maca root for stress relief and energy balance. In other embodiments of the subject invention, the beverage contains probiotics to support digestive health. In other embodiments of the subject invention, the beverage is sweetened with natural sweeteners such as honey, monk fruit, or agave instead of refined sugar. In other embodiments of the subject invention, the beverage is unsweetened to cater to consumers who prefer coffee without added sugar. In other embodiments of the subject invention, the beverage contains a sugar substitute such as stevia or erythritol for a low-calorie option. In other embodiments of the subject invention, the beverage is dairy-free and made with plant-based milk substitutes such as almond milk, oat milk, coconut milk, or soy milk. In other embodiments of the subject invention, the beverage is lactose-free to accommodate consumers with dairy sensitivities. In other embodiments of the subject invention, the beverage is gluten-free for individuals with gluten intolerance or celiac disease. In other embodiments of the subject invention, the beverage is keto-friendly with a high-fat, low-carb formulation. In other embodiments of the subject invention, the beverage is formulated as a meal replacement by incorporating protein and fiber. In other embodiments of the subject invention, the beverage is fortified with vitamins and minerals such as vitamin D, calcium, or iron. In other embodiments of the subject invention, the beverage is infused with antioxidants from sources such as green coffee extract or cacao. In other embodiments of the subject invention, the beverage includes a blend of spices such as cinnamon, nutmeg, and cardamom for added depth of flavor. In other embodiments of the subject invention, the beverage contains real fruit extracts for natural flavoring. In other embodiments of the subject invention, the beverage is designed for consumption hot or cold, depending on consumer preference. In other embodiments of the subject invention, the beverage includes micro ground coffee particles to enhance the texture and aroma. In other embodiments of the subject invention, the beverage is crafted using single-origin coffee beans for a distinct and premium flavor profile. In other embodiments of the subject invention, the beverage includes a blend of arabica and robusta beans to balance flavor and caffeine content. In other embodiments of the subject invention, the beverage is carbonated to provide a sparkling coffee experience. In other embodiments of the subject invention, the beverage features a unique roasting profile tailored to enhance the natural flavors of the coffee. In other embodiments of the subject invention, the beverage is produced in small batches to ensure quality and consistency. In other embodiments of the subject invention, the beverage is aged in oak barrels to infuse subtle wood and vanilla notes. In other embodiments of the subject invention, the beverage contains a whipped topping layer for a dessert-like experience. In other embodiments of the subject invention, the beverage contains a natural foam layer achieved through nitrogen infusion. In other embodiments of the subject invention, the packaging is made from recyclable materials to promote environmental sustainability. In other embodiments of the subject invention, the packaging includes a resealable lid for multi-use consumption. In other embodiments of the subject invention, the packaging is designed with an easy-pour spout to minimize spills. In other embodiments of the subject invention, the packaging is tamper-evident to ensure product integrity. In other embodiments of the subject invention, the packaging features a QR code that provides information on the sourcing and processing of the coffee. In other embodiments of the subject invention, the packaging includes a temperature-sensitive label that changes color to indicate optimal drinking temperature. In other embodiments of the subject invention, the packaging includes a transparent window to allow consumers to view the beverage inside. In other embodiments of the subject invention, the packaging features embossed or textured elements for an elevated tactile experience. In other embodiments of the subject invention, the packaging incorporates a dual-chamber system that allows consumers to mix flavors before consumption. In other embodiments of the subject invention, the packaging includes a self-heating element to warm the beverage on demand. In other embodiments of the subject invention, the packaging is microwave-safe for convenient heating. In other embodiments of the subject invention, the beverage includes a natural energy boost from green tea extract or yerba mate. In other embodiments of the subject invention, the beverage contains a proprietary blend of coffee and botanicals for relaxation and stress relief. In other embodiments of the subject invention, the beverage features a cold foam topping similar to coffeehouse-style drinks. In other embodiments of the subject invention, the beverage is produced with a slow-brew process to enhance flavor extraction. In other embodiments of the subject invention, the beverage includes a limited-edition seasonal flavor available for a specific time of year. In other embodiments of the subject invention, the beverage is packaged in a vintage-inspired design to appeal to nostalgic consumers. In other embodiments of the subject invention, the beverage includes a functional blend of mushrooms such as lion's mane for cognitive benefits. In other embodiments of the subject invention, the beverage is made with ultra-filtered coffee for enhanced clarity and purity. In other embodiments of the subject invention, the beverage is designed for direct consumption or use in coffee-based cocktails. In other embodiments of the subject invention, the beverage is formulated with a proprietary blend of exotic spices for a globally inspired flavor experience. In other embodiments of the subject invention, the beverage contains a natural source of caffeine from unroasted green coffee beans. In other embodiments of the subject invention, the beverage includes sustainably sourced cacao for added richness. In other embodiments of the subject invention, the beverage is offered in a multipack featuring customizable flavor assortments. In other embodiments of the subject invention, the beverage is designed to be paired with specific food items for enhanced taste experiences. In other embodiments of the subject invention, the beverage includes a plant-based protein source for added nutritional value. In other embodiments of the subject invention, the beverage incorporates a traditional brewing method such as Turkish or Vietnamese-style coffee preparation. In other embodiments of the subject invention, the beverage features a hint of smoked flavor achieved through specialty roasting techniques. In other embodiments of the subject invention, the beverage is available in a concentrated format for dilution with water or milk. In other embodiments of the subject invention, the beverage is crafted using a combination of cold brew and espresso for a layered flavor experience. In other embodiments of the subject invention, the beverage includes a limited-edition regional blend inspired by a specific coffee-growing region. In other embodiments of the subject invention, the beverage is infused with saffron for an exotic and luxurious taste. In other embodiments of the subject invention, the beverage is created using a double fermentation process to enhance complexity. In other embodiments of the subject invention, the beverage is brewed with a proprietary water filtration system for enhanced purity. In other embodiments of the subject invention, the beverage includes edible gold flakes for a premium offering. In other embodiments of the subject invention, the beverage features a nitro-flavored variant infused with vanilla bean. In other embodiments of the subject invention, the beverage includes a balanced blend of sweet and savory elements for a unique taste profile. In other embodiments of the subject invention, the beverage includes a floral infusion such as lavender or rose. In other embodiments of the subject invention, the beverage incorporates culinary-grade essential oils for enhanced aromatics.

### BRIEF DESCRIPTION OF THE DRAWINGS

Advantages of the present invention will be apparent from the following detailed description of embodiments, which description should be considered in conjunction with the accompanying drawings, in which:

FIG. 1 Illustrates a side view of a first embodiment of individual can packaging containing a coffee flavor.

FIG. 2 Illustrates a top open view of the first embodiment of individual can packaging containing a coffee flavor.

FIG. 3 a bottom view of the first embodiment of individual can packaging containing a coffee flavor.

FIG. 4 Illustrates another side view of a second embodiment of individual can packaging containing a coffee flavor.

FIG. 5 another side view of a third embodiment of individual can packaging containing a coffee flavor.

FIG. 6 Illustrates a perspective view of an embodiment of multiple can packaging containing a coffee flavor.

### DESCRIPTION OF THE INVENTION

This invention encompasses a new range of coffee beverages, each with a distinct flavor, packaged in individual cans or bottles.

The first and most important aspect of the invention is the wide variety of coffee flavors. The available flavors in the invention include a wide variety of options such as Almond, Amaretto, Apricot Cake, Banana Bread, Banana Nut Bread, Birthday Cake, Black Cherry, Blueberry Cobbler, Butter Pecan Ice Cream, Butter Rum Cake, Butterscotch, Butterscotch Toffee, Caramel, Caramel Apple, Caramel Pecan Pie, Caramel Vanilla Latte, Cherry Vanilla, Chocolate Fudge Brownie, Chocolate Marshmallow, Chocolate Peanut Butter Cup, Chocolate Raspberry, Cinnamon Bun, Cinnamon Roll, Cinnamon Spice, Coconut, Coconut Macaroon, Colombian Coffee, Costa Rican Gladiola, Costa Rican La Minita, Crème Brûlée, French Vanilla, Hazelnut, Irish Cream, Maple, Mocha Mint Café, Orange Walnut, Peppermint, Pumpkin, Pumpkin Spice, Salted Caramel, S'mores, Toffee Nut, Toasted Marshmallow, Vanilla, and White Chocolate.

These flavors are unique to the market and are designed to cater to diverse consumer preferences. The flavors range from classic coffee shop staples to innovative, dessert-like blends. Each can or bottle is designed for individual sale, allowing consumers to enjoy coffee without the need for preparation or visiting a coffee shop.

These flavors are classified into several categories:
Classic and Nutty Flavors: Almond, Amaretto, Hazelnut, French Vanilla
Fruity Flavors: Black Cherry, Blueberry Cobbler, Cherry Vanilla, Orange Walnut
Dessert-Inspired Flavors: Crème Brûlée, Birthday Cake, Chocolate Peanut Butter Cup, Toffee Nut
Seasonal and Holiday Flavors: Pumpkin Spice, Peppermint, S'mores, Salted Caramel
Gourmet and Exotic Flavors: Costa Rican Gladiola, Colombian Coffee, Irish Cream, Mocha Mint Café

Additional available flavors in the invention include a wide variety of options such as Almond Biscotti, Almond Butter, Almond Caramel, Almond Creme, Almond Frosting, Almond Honey, Almond Joy (chocolate, coconut, almond), Almond Maple Crunch, Almond Mocha Crunch, Almond Toffee, Amaretto, Apple Butter, Apple Cinnamon, Apple Pie, Apricot Cake, Baked Apple, Banana, Banana Nut, Black Cherry, Black Forest (chocolate and cherry), Black Walnut, Blueberry, Blueberry Muffin, Bourbon Caramel, Bourbon Pecan, Bourbon Vanilla, Bourbon Vanilla Cream, Brown Butter, Brown Butter Hazelnut, Brown Sugar, Butter Pecan, Butterscotch, Butterscotch Toffee, Cappuccino, Caramel, Caramel Macchiato, Caramel Pecan Pie, Caramel Vanilla Latte, Caramelized Sugar, Cardamom, Chai Latte, Chai Spice, Chestnut Mocha, Chestnut Praline, Cherry, Cherry Vanilla, Chocolate Almond Crunch, Chocolate Biscotti, Chocolate Blueberry, Chocolate Chili, Chocolate Covered Pretzel, Chocolate Fudge, Chocolate Fudge Brownie, Chocolate Hazelnut, Chocolate Macaroon, Chocolate Marshmallow, Chocolate Marshmallow Mocha, Chocolate Mint, Chocolate Orange, Chocolate Peanut Butter, Chocolate Pistachio, Chocolate Pumpkin Spice, Chocolate Raspberry, Chocolate Rum, Chocolate Truffle, Choco-Cherry Crunch, Choco-Orange Spice, Cinnamon, Cinnamon Almond, Cinnamon Hazelnut, Cinnamon Pumpkin, Cinnamon Roll, Cinnamon Spice, Cinnamon Sugar, Cinnamon Toast Crunch, Coconut, Coconut Cream Pie, Coconut Mocha, Coffee Cake, Coffee Cream Pie, Cocoa Nib Crunch, Crème Brûlée, Crèeme de Menthe, Dark Almond Spice, Dark Chocolate, Dark Chocolate Orange, Dark Cocoa, Dark Espresso Caramel, Dark Mocha, Dark Mocha Hazelnut, Dark Mocha Mint, Double Chocolate Fudge, Eggnog, Espresso, Espresso Martini, French Toast, French Vanilla, Ginger Almond, Ginger Caramel, Ginger Snap, Gingerbread, Hazelnut, Hazelnut Biscotti, Hazelnut Cream, Hazelnut Cream Swirl, Hazelnut Mocha, Hazelnut Mocha Swirl, Hazelnut Praline, Hazelnut Toffee, Honey, Honey Almond, Honey Cinnamon, Honey Glaze, Honey Lavender, Honey Nut, Honey Pecan, Hot Buttered Rum, Irish Cream, Italian Cream, Key Lime Coconut, Key Lime Pie, Lavender, Lemon, Lemon Mint, Lemon Zest, Macadamia Nut, Mango Tango, Maple, Maple Bourbon, Maple Cinnamon, Maple Crème, Maple Hazelnut, Maple Pecan, Maple Spice, Maple Walnut, Marshmallow Cream, Mexican Chocolate, Mint Chocolate Chip, Mocha, Mocha Almond, Mocha Caramel Crunch, Mocha Chai, Mocha Coconut, Mocha Hazelnut, Mocha Macaroon, Mocha Mint, Mocha Nut Crunch, Mocha Peppermint, Mocha Raspberry, Mocha Swirl, Molasses, Nutmeg, Orange Almond, Orange Clove, Orange Cream, Orange Zest, Peanut Brittle, Peanut Butter, Peanut Butter Cup, Peppermint, Peppermint Mocha, Peppermint Swirl, Pineapple, Pineapple Coconut, Pistachio, Pina Colada, Praline, Pumpkin Caramel, Pumpkin Mocha, Pumpkin Spice, Pumpkin Vanilla, Raspberry, Raspberry Cream, Raspberry Mocha, Raspberry Rose, Raspberry Swirl, Rocky Road (chocolate, marshmallow, nuts), Rose, Rum, Rum Cream, Rum Raisin, Saffron Vanilla, Salted Caramel, Salted Honey, Salted Maple, Salted Toffee, Sea Salt Caramel, S'mores, Snickerdoodle, Spiced Apple, Spiced Cranberry, Strawberry, Sweet Cream, Sweet Mint, Sweet Molasses, Sweetened Condensed Milk, Tiramisu, Toasted Almond, Toasted Caramel, Toasted Coconut, Toasted Marshmallow, Tropical Twist (pineapple, mango, coconut), Vanilla, Vanilla Bean, Vanilla Bourbon, Vanilla Hazelnut, Vanilla Nut, Vanilla Spice, Winter Mint, Winter Spice.

These flavors include:

Nut-Based Flavors: Almond, Almond Biscotti, Almond Butter, Almond Caramel, Almond Creme, Almond Frosting, Almond Honey, Almond Joy (chocolate, coconut, almond), Almond Maple Crunch, Almond Mocha Crunch, Almond Toffee, Amaretto, Black Walnut, Butter Pecan, Hazelnut, Hazelnut Biscotti, Hazelnut Cream, Hazelnut Cream Swirl, Hazelnut Mocha, Hazelnut Mocha Swirl, Hazelnut Praline, Hazelnut Toffee, Macadamia Nut, Peanut Brittle, Peanut Butter, Peanut Butter Cup, Pecan Pie, Pistachio, Rocky Road (chocolate, marshmallow, nuts), Toasted Almond, Honey Nut, Honey Pecan, Maple Walnut.

Fruit-Based Flavors: Apple Butter, Apple Cinnamon, Apple Pie, Apricot Cake, Banana, Banana Nut, Black Cherry, Blueberry, Blueberry Muffin, Cherry, Cherry Vanilla, Key Lime Coconut, Key Lime Pie, Lemon, Lemon Mint, Lemon Zest, Mango Tango, Orange Almond, Orange Clove, Orange Cream, Orange Zest, Pineapple, Pineapple Coconut, Raspberry, Raspberry Cream, Raspberry Mocha, Raspberry Rose, Raspberry Swirl, Spiced Apple, Spiced Cranberry, Strawberry, and Tropical Twist (pineapple, mango, coconut).

Caramel and Butterscotch Flavors: Bourbon Caramel, Caramel, Caramel Macchiato, Caramel Pecan Pie, Caramel Vanilla Latte, Caramelized Sugar, Butterscotch, Butterscotch Toffee, Salted Caramel, Sea Salt Caramel, Salted Maple, Salted Honey, and Toasted Caramel.

Chocolate-Based Flavors: Black Forest (chocolate and cherry), Chocolate Almond Crunch, Chocolate Biscotti, Chocolate Blueberry, Chocolate Chili, Chocolate Covered Pretzel, Chocolate Fudge, Chocolate Fudge Brownie, Chocolate Hazelnut, Chocolate Macaroon, Chocolate Marshmallow, Chocolate Marshmallow Mocha, Chocolate Mint, Chocolate Orange, Chocolate Peanut Butter, Chocolate Pistachio, Chocolate Pumpkin Spice, Chocolate Raspberry, Chocolate Rum, Chocolate Truffle, Choco-Cherry Crunch, Choco-Orange Spice, Dark Almond Spice, Dark Chocolate, Dark Chocolate Orange, Dark Cocoa, Dark Espresso Caramel, Dark Mocha, Dark Mocha Hazelnut, Dark Mocha Mint, Double Chocolate Fudge, Mexican Chocolate, Mint Chocolate Chip, Mocha, Mocha Almond, Mocha Caramel Crunch, Mocha Chai, Mocha Coconut, Mocha Hazelnut, Mocha Macaroon, Mocha Mint, Mocha Nut Crunch, Mocha Peppermint, Mocha Raspberry, Mocha Swirl, Rocky Road (chocolate, marshmallow, nuts), and Chocolate Pistachio.

Spice-Based Flavors: Cardamom, Chai Latte, Chai Spice, Cinnamon, Cinnamon Almond, Cinnamon Hazelnut, Cinnamon Pumpkin, Cinnamon Roll, Cinnamon Spice, Cinnamon Sugar, Cinnamon Toast Crunch, Ginger Almond, Ginger Caramel, Ginger Snap, Gingerbread, Nutmeg, Saffron Vanilla, Snickerdoodle, and Winter Spice.

Creamy and Sweet Flavors: Sweet Cream, Sweet Mint, Sweetened Condensed Milk, Marshmallow Cream, Toasted Marshmallow, Italian Cream, French Vanilla, Vanilla Bean, Vanilla Bourbon, Vanilla Hazelnut, Vanilla Nut, Vanilla Spice, Creamy Vanilla, Espresso, Espresso Martini, Honey, Honey Cinnamon, Honey Lavender, Maple, Maple Bourbon, Maple Cinnamon, Maple Crème, Maple Hazelnut, Maple Pecan, Maple Spice, Crème Brûlée, Crème de Menthe, Coffee Cream Pie, Coffee Cake, Hot Buttered Rum, Sweet Molasses, Brown Butter, Brown Butter Hazelnut, and Brown Sugar.

Dessert and Seasonal Flavors: Baked Apple, Bourbon Pecan, Cappuccino, Chestnut Mocha, Chestnut Praline, French Toast, Eggnog, Key Lime Coconut, Mocha Caramel Crunch, Pumpkin Caramel, Pumpkin Mocha, Pumpkin Spice, Pumpkin Vanilla, Rum, Rum Cream, Rum Raisin, S'mores, Spiced Apple, Tiramisu, Toasted Coconut, Winter Mint, and Vanilla.

Each of these flavors is created with high-quality ingredients, including real coffee, milk or milk substitutes, sweeteners, and natural or artificial flavorings. The coffee beverages are shelf-stable, meaning they do not require refrigeration and can be enjoyed straight from the can or bottle.

In terms of flavor combinations, the possibilities are vast. Traditional flavor profiles like Vanilla and Cinnamon Roll pair seamlessly with coffee, offering familiar comfort. More exotic options such as Apricot Cake and Banana Nut Bread provide a unique twist, appealing to adventurous coffee drinkers. Rich, decadent flavors like Butter Pecan Ice Cream and Butterscotch Toffee create a luxurious coffee experience, perfect for consumers who enjoy a sweeter, more dessert-like beverage. For those seeking a refreshing fruit twist, flavors like Black Cherry and Blueberry Cobbler offer a blend of fruity brightness with the boldness of coffee.

The invention also includes coffee flavors that highlight regional and specialty coffee beans. For example, Colombian Coffee and Costa Rican Gladiola bring the unique flavor profiles of specific coffee-growing regions to the consumer's palate. These options appeal to coffee aficionados who appreciate the nuances of different bean varieties and roasting techniques. By offering a mix of traditional and regional flavors, the invention caters to both casual coffee drinkers and connoisseurs alike.

In addition to the diverse flavor options, the beverages may also feature different types of coffee bases. While the standard mixture contains regular coffee, there are variations that use decaffeinated coffee or coffee substitutes for consumers who want the flavor of coffee without the caffeine. These options are particularly beneficial for individuals who are sensitive to caffeine or who want to enjoy coffee in the evening without affecting their sleep. The invention also offers sugar-free and dairy-free variations, ensuring that the product is accessible to a wide audience with varying dietary needs.

The flavor combinations in the invention are further enhanced by the use of complementary ingredients such as flavored syrups. For example, flavors like Caramel Pecan Pie and Salted Caramel are elevated by the inclusion of sweet, nutty, and slightly salty notes, creating a rich, well-rounded taste. Additionally, flavors like Cherry Vanilla and Chocolate Fudge Brownie introduce layers of complexity, combining fruity or chocolatey notes with the smoothness of vanilla or other base flavors.

The variety of coffee flavors extends to more complex blends, such as Caramel Vanilla Latte and Cinnamon Bun, which are inspired by popular coffeehouse drinks. These flavors offer the same quality and taste as specialty café drinks but in a convenient, ready-to-drink format. Amaretto, Butter Rum Cake, and Irish Cream add a touch of liqueur-inspired flavor without any alcohol content, providing a sophisticated option for consumers who enjoy the richness and depth of these classic flavors.

For health-conscious consumers, the invention offers flavors that are sweetened with natural sweeteners like Stevia or Monk Fruit, as well as unsweetened options for those who prefer to avoid added sugars altogether. Flavors like Coconut, Coconut Macaroon and Maple retain their sweetness naturally, appealing to consumers who want a balanced, yet indulgent coffee drink without the use of refined sugars.

The beverages themselves may be crafted using a mixture of coffee, milk, and sweetening agents, with optional variations such as sugar substitutes, milk substitutes, and additional ingredients like flavored syrups or substitutes. This allows the product to appeal to a broader audience, including those who prefer dairy-free or sugar-free options.

The coffee beverage mixture may also include substitutions for one or more components, such as replacing milk, sugar, or coffee with alternatives that cater to different dietary preferences. For example, the beverage mixture can be made with sugar substitutes, milk substitutes, or flavored syrups to offer additional customization for consumers. This ensures that the product can cater to health-conscious individuals or those with dietary restrictions.

The beverages are shelf-stable and ready for immediate consumption, making them ideal for consumers who need a convenient, portable coffee option for their busy lifestyles. The mixture of high-quality ingredients ensures that the coffee retains its flavor and freshness, even when consumed on the go.

### Individual Packaging

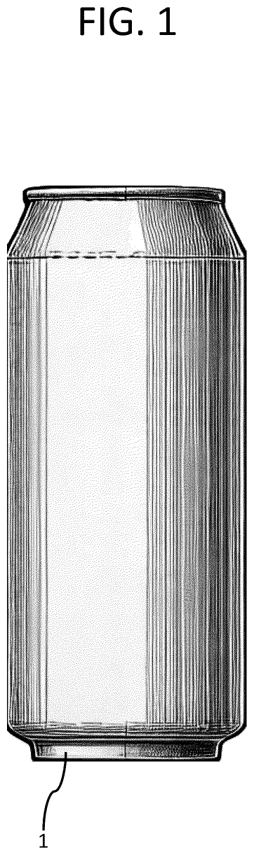

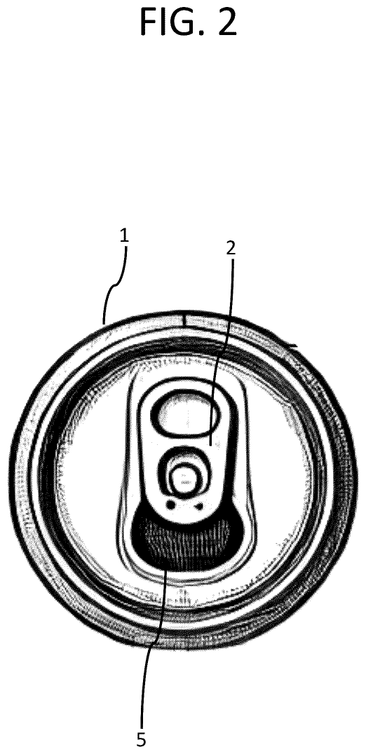

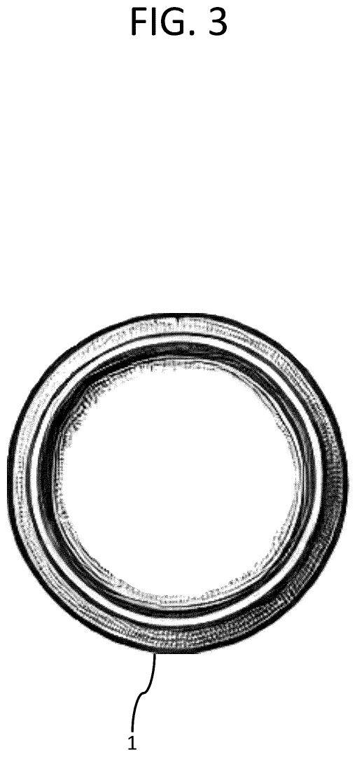

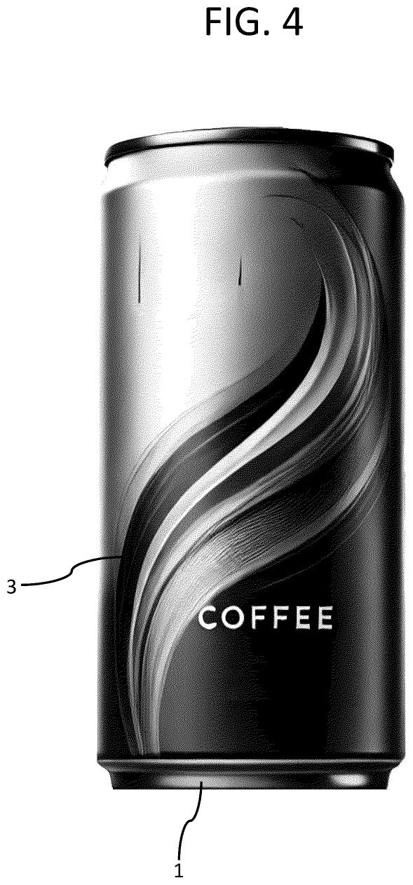

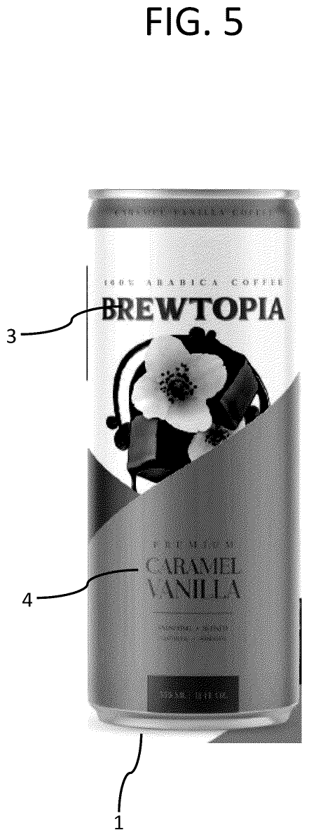

As illustrated in FIGS. 1-5, coffee beverages are packaged in individual cans 1 with a pop-top 2 or bottles. These containers are designed for portability, making it easy for consumers to grab a can and enjoy it wherever they go. Each can or bottle is clearly labeled 3 with its respective flavor 4, ensuring consumers can easily identify their preferred options. The packaging is designed to maintain the flavor and freshness of the coffee, even after extended periods on store shelves.

Each can may be a small, cylindrical aluminum vessel, typically 4.83 inches tall and 2.6 inches in diameter. In other embodiments of the subject invention, the cans may contain 355 ml in coffee beverages.

The cans are sleek and metallic, with vivid labeling 3 that mirrors the flavor and branding of the coffee. Many coffee brands use eye-catching designs and vibrant colors to differentiate between flavors.

The cans themselves are topped with the familiar pop-top 2 or pull-tab, an aluminum ring that, when lifted and pulled back, breaks the seal of the can opening 5.

### Take-Home Box Packaging

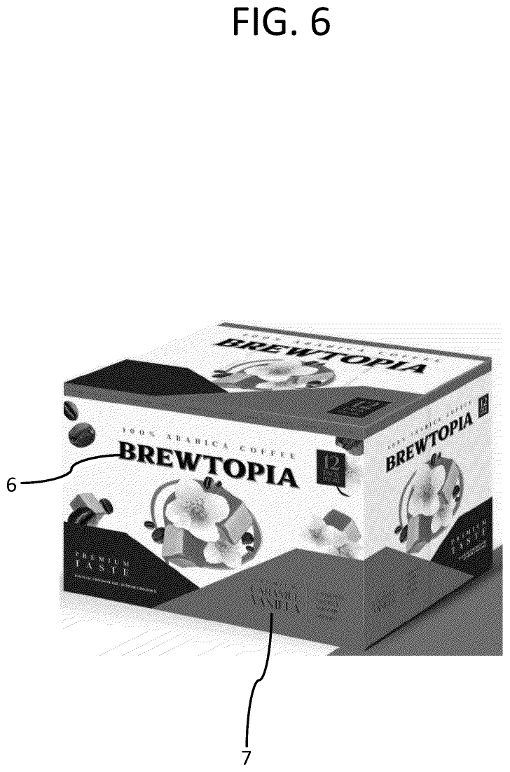

As illustrated in FIG. 6, in addition to individual cans 1 or bottles, the invention includes secondary packaging in the form of take-home boxes 6 that hold 8, 12, or 24 cans or bottles. These boxes are designed for easy transport, allowing consumers to purchase multiple coffee flavors in one convenient package. The box packaging is sturdy and features flavor listings 7 on the outside, helping consumers choose their preferred variety at a glance. These take-home boxes 6 are sold in grocery stores, liquor stores, and convenience stores, making it easy for consumers to bring home their favorite coffee flavors for daily enjoyment.

The outer packaging of these 12-packs is often a rectangular cardboard box, designed to be compact and easy to carry. The box is usually brightly colored, reflecting the branding of the coffee inside, with bold logos and images of the cans themselves. Most brands also include an easy-tear perforation on one side, allowing consumers to access the cans without damaging the box. This design feature is especially useful for those who like to store their coffee in the fridge; they can simply slide the cans out one by one without removing the entire pack.

In some cases, all cans in the package will contain the same flavor, while in other configurations, the package may offer an assortment of different flavors. This gives consumers flexibility in choosing either single-flavor or multi-flavor packs based on their preferences.

The package is designed to protect the cans or bottles from impact during transport, ensuring the product reaches consumers in optimal condition. The outer packaging will also clearly display flavor descriptions on the exterior, assisting customers in making an informed selection. In addition, the packaging is made from recyclable materials, making it an eco-friendly option that aligns with modern sustainability standards.

Furthermore, the cans within the package are stackable, contributing to space-saving during storage or transport, and may also feature resealable lids for added convenience

Retailers may choose to purchase the 12-can packaged set of coffee beverages and sell the cans individually to cater to customers seeking on-the-go options or those who prefer to sample a flavor before committing to a larger purchase. By offering individual cans, retailers can provide flexibility for consumers who want to try multiple flavors without purchasing an entire pack. This strategy allows retailers to attract a broader customer base, including those who may not want a full pack but still desire high-quality, ready-to-drink coffee.

Selling individual cans also enables retailers to maximize profits by pricing the cans at a premium compared to the per-can price in a 12-pack. Additionally, placing individual cans at checkout counters or in refrigerated sections can increase impulse purchases from customers seeking a convenient, ready-to-drink coffee option during their shopping trips. This approach gives retailers the opportunity to capitalize on both bulk sales of the full 12-can package and single-can sales to meet diverse consumer needs.

Moreover, selling the cans individually offers retailers the chance to gather consumer feedback on which flavors are most popular. This data can inform future purchasing decisions, allowing retailers to stock more of the best-selling flavors in single-can format, specific flavor packages, or suggest specific combinations in future variety packs.

In conclusion, the present invention provides a versatile and convenient solution for coffee drinkers who value variety, convenience, and quality. The wide array of flavors—ranging from traditional favorites like Caramel and French Vanilla to innovative blends like Chocolate Marshmallow and Banana Nut Bread—ensures that there is something for every taste preference. The packaging is designed for durability and ease of use, while the inclusion of options for dietary restrictions, seasonal variations, and specialty coffee blends makes this product both versatile and inclusive. Whether for personal consumption, sharing, or gifting, this packaged set of coffee beverages offers an exceptional coffee experience in a portable, ready-to-drink format.

While several variations of the present invention have been illustrated by way of example in particular embodiments, it is apparent that further embodiments could be developed within the spirit and scope of the present invention. However, it is to be expressly understood that such modifications and adaptations are within the spirit and scope of the present invention, and are inclusive, but not limited to the following appended claims as set forth.

1. A packaged set of coffee beverages, comprising: a variety of coffee flavors, each flavor in an individual container, wherein each container is a pop-top can, designed for direct consumption; and further wherein the coffee beverages are shelf-stable, pre-mixed, and ready to consume without requiring preparation.

2. A method of packaging coffee beverages, comprising:
(a) packaging multiple flavors of coffee in individual cans;
(b) placing said cans or bottles into take-home boxes capable of holding 8, 12, or 24 units for retail sale; wherein the boxes being designed for easy transport and retail sales in grocery stores, convenience stores, and liquor stores.

3. The coffee beverage of claim 1, wherein the beverage is sweetened with natural sweeteners.

4. The coffee beverage of claim 1, wherein the beverage is sweetened with artificial sweeteners.

5. The coffee beverage of claim 1, wherein the beverage contains milk substitutes.

6. The coffee beverage of claim 1, wherein the beverage is dairy-free.

7. The coffee beverage of claim 1, wherein the beverage is unsweetened.

8. The coffee beverage of claim 1, wherein the beverage contains at least one flavored syrup.

9. The coffee beverage of claim 1, wherein the container is a resealable can.

10. The coffee beverage of claim 1, wherein the flavor includes Salted Caramel.

11. The coffee beverage of claim 1, wherein the flavor includes Peppermint.

12. The coffee beverage of claim 2, wherein the take-home box includes flavor descriptions on the exterior.

13. The coffee beverage of claim 2, wherein the take-home box is made from recyclable materials.

14. The coffee beverage of claim 2, wherein the box is capable of holding 24 units.

15. The coffee beverage of claim 1, wherein the flavor includes Costa Rican Gladiola.

16. The coffee beverage of claim 1, wherein the flavor includes Mocha Mint Café.

17. The coffee beverage of claim 1, wherein the flavor includes Chocolate Peanut Butter Cup.

18. The coffee beverage of claim 1, wherein the flavor includes Blueberry Cobbler.

19. The coffee beverage of claim 1, wherein the flavor includes Toasted Marshmallow.

20. The coffee beverage of claim 2, wherein the packaging includes a combination of at least five flavors.
